(19) United States
(12) Patent Application Publication
(10) Pub. No.: US 2016/0319220 A1
(43) Pub. Date: Nov. 3, 2016

(54) CANDLE HAVING DIFFERENT FRAGRANCE CHARACTERISTICS AND METHODS OF MAKING AND USING THE SAME

(71) Applicant: WTF Pranks LLC, Chapel Hill, NC (US)

(72) Inventor: Tyler Ward, Chapel Hill, NC (US)

(21) Appl. No.: 15/144,220

(22) Filed: May 2, 2016

Related U.S. Application Data
(60) Provisional application No. 62/155,120, filed on Apr. 30, 2015.

(51) Int. Cl. C11C 5/00; F23D 3/16

(52) U.S. Cl. CPC C11C 5/008; F23D 3/16; C11C 5/002; C11C 5/004

(57) ABSTRACT

A candle includes a wick extending along a length of the candle and having an exposed portion for burning, a first layer defined proximal the exposed portion where the first layer has a desirable fragrance impregnated therein, and a second layer positioned below the first layer where the second layer has an undesirable fragrance impregnated therein such that as the wick burns through the first layer into the second layer, the fragrance sensed by a person transitions from desirable to undesirable.

### CROSS-REFERENCE TO RELATED APPLICATION

This application claims the benefit of U.S. Provisional Patent Application No. 62/155,120, filed Apr. 30, 2015, the entire disclosure of which is hereby incorporated by reference.

### FIELD OF THE INVENTION

The presently disclosed subject matter relates generally to multilayer candles having different fragrance characteristics in each of the vertical layers.

### BACKGROUND

Candles that contain fragrances have been offered for several years and have shown enormous consumer appeal. Classic layered and scented candles are known to consist of familiar, expected, and obvious scents. However, a candle that is different from the classic scented layered candle and catches users off guard would be an interesting novelty item.

### SUMMARY

In some embodiments, the presently disclosed subject matter is directed to a candle comprising at least one wick extending along a length of the candle and having an exposed portion for burning. In some embodiments, the candle further comprises a first layer defined proximal the exposed portion, the first layer comprising a fuel element having a desirable fragrance impregnated therein. In some embodiments, the candle comprises a second layer positioned below the first layer, the second layer comprising a fuel element having an undesirable fragrance impregnated therein such that as the wick burns through the first layer into the second layer, the fragrance transitions from desirable to undesirable, wherein there is a distinct transition between the first and second layers.

In some embodiments, the presently disclosed subject matter is directed to a method of making the disclosed candle. Particularly, the method comprises providing a container or mold; positioning at least one wick in the container or mold such that the wick extends at least partially along the length of the container or mold; heating the second layer to a first temperature and pouring it into the container or mold; allowing the second layer to solidify; heating the first layer to a second temperature that is less than the first temperature and pouring it into the container or mold; allowing the second layer to solidify; and recovering the candle from the container or mold.

### BRIEF DESCRIPTION OF THE DRAWINGS

FIG. 1 illustrates a 2-layer candle in accordance with some embodiments of the presently disclosed subject matter.

FIG. 2 illustrates a 3-layer candle in accordance with some embodiments of the presently disclosed subject matter.

FIG. 3 is a flow chart depicting one method of making the disclosed candle according to some embodiments of the presently disclosed subject matter.

### DETAILED DESCRIPTION

The presently disclosed subject matter will now be described more fully hereinafter with reference to the accompanying drawings, in which some (but not all) embodiments are shown. Indeed, the presently disclosed subject matter may be embodied in many different forms and should not be construed as limited to the embodiments set forth herein; rather, these embodiments are provided so that the instant disclosure will satisfy applicable legal requirements. Like numbers refer to like elements throughout.

Unless defined otherwise, all technical terms used herein have the same meaning as commonly understood to one of ordinary skill in the art to which the presently disclosed subject matter belongs.

Following long standing patent law convention, the terms “a”, “an”, and “the” refer to “one or more” when used in the subject application, including the claims. Thus, for example, reference to “a layer” includes a plurality of such layers, and so forth.

Unless indicated otherwise, all numbers expressing quantities of components, reaction conditions, and so forth used in the specification and claims are to be understood as being modified in all instances by the term “about.” Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, percentage, and the like can encompass variations of, and in some embodiments, ±20%, in some embodiments ±10%, in some embodiments ±5%, in some embodiments ±1%, in some embodiments ±0.5%, and in some embodiments ±0.1%, from the specified amount, as such variations are appropriated in the disclosed package and methods.

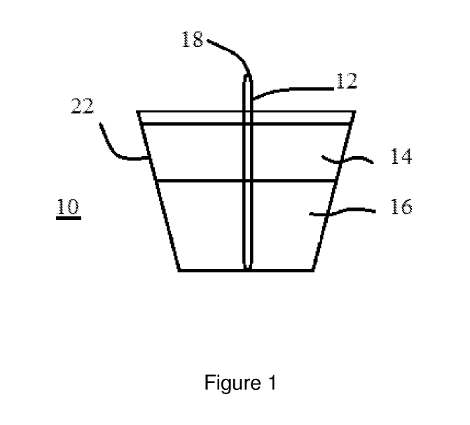

The presently disclosed subject matter is directed to a candle that comprises at least two layers comprising different fragrances. Particularly, the disclosed candle provides a first layer with a pleasant fragrance and a second layer with an unpleasant fragrance. FIG. 1 illustrates one embodiment of candle 10 as disclosed herein. The candle comprises wick 12 extending at least partially along the length of candle 10 and having exposed portion 18 for burning. Wick 12 can comprise any suitable material known and used in the art, including (but not limited to) cotton, paper, linen, rayon, nylon, hemp, wood, blends thereof, or other suitable wick materials. Wick 12 can be of any shape and/or construction, including woven, braided, flat, square, round, cylindrical, and the like. In some embodiments, wick 12 can include a wick core to help support the wick as the candle burns. The wick core can comprise any suitable material, such as cotton, metal, paper, polyethylene fiber, and the like. In some embodiments, the wick can include a metallic support to hold the wick in place.

As shown in FIG. 1, first layer 14 is positioned proximal to wick exposed portion 18, wherein the first layer comprises a fuel element (such as a wax) with a desirable fragrance impregnated therein. Fuel elements suitable for use with the first layer can include (but are not limited to) paraffin wax, triglyceride wax (such as vegetable wax), animal wax (such as tallow), soy wax, beeswax, stearin wax, microcrystalline wax, carnauba wax, palm wax, and blends thereof. It should be understood that generally all waxes (natural or synthetic) common to candle-making are suitable in the context of the presently disclosed subject matter.

The desirable fragrance impregnated in the fuel element of first layer 14 can in some embodiments be from a synthetically formed material or from a naturally derived oil. Suitable desirable fragrances can be selected from a single material or a mixture of perfumes, perfume oils, and/or essential oils. Fragrances suitable for use in the first layer of the disclosed candle can be selected from the large palette of desirable fragrances used in the candle industry. For example, the desirable fragrance can include floral scents (rose, iris, lilac, pine, lavender, fresh flowers, and the like), food-related scents (chocolate, berries, mint, pizza, apple pie, lemon, strawberry, vanilla, and the like), and/or any of the other available pleasing fragrances known and used in the art.

Second layer 16 is positioned below first layer 14 and comprises a fuel element (such as a wax) with an undesirable fragrance impregnated therein such that as wick 12 burns through the first layer into the second layer, the fragrance sensed by a user transitions from desirable to undesirable. Fuel elements suitable for use with the first layer can include (but are not limited to) paraffin wax, triglyceride wax (such as vegetable wax), tallow, soy wax, beeswax, and blends thereof. It should be understood that generally all waxes (natural or synthetic) common to candle-making are suitable in the context of the presently disclosed subject matter.

The undesirable fragrance impregnated in the fuel element of second layer 16 can in some embodiments be from a synthetically formed material or from a naturally derived oil. Suitable undesirable or non-pleasing fragrances can include (but are not limited to) dirty laundry, bodily fluid, gaseous discharge, and the like. In one or more embodiments, the undesirable fragrance is one of a pungent or obnoxious fragrance configured to produce a pungent or obnoxious fragrance when burned. In some embodiments, second layer 16 can comprise about 150% or greater concentration of fragrance compared to the fragrance concentration of first layer 14. In some embodiments, the fragrance concentration of the second layer can be at about 125-250% of the fragrance concentration in the first layer.

In some embodiments, candle additives can be used with the disclosed fuel elements to help control the melting temperature, hardness, shrinkage, and/or opacity of the fuel substance. For example, wax crystal modifier can be used to help bind fragrance and to prevent bleed of the fragrance from the fuel element (e.g., wax).

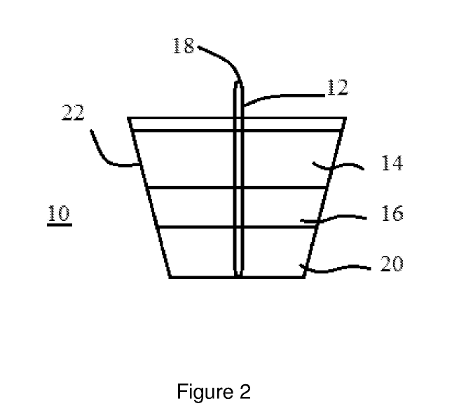

As illustrated in FIG. 2, in some embodiments, candle 10 comprises third layer 20 positioned below second layer 16. In some embodiments, the third layer is not impregnated with a fragrance as a cost-effective manufacturing option. Particularly, third layer 20 can be a low-grade or low cost wax that is provided as a filler since it is unlikely that a user would allow the wick to burn through second layer 16 due to its unpleasant odor.

In manufacturing candle 10, the fuel element of second layer 16 is poured at a first temperature into a mold or a container housing wick 12, and the fuel element of first layer 14 is poured at a second temperature that is less than the first temperature into the mold or container. In this manner, the second temperature is selected to not melt second layer 16 when first layer 14 is being poured. As a result, a distinct transition occurs between the first and second layers that advantageously provides for a distinct change from the pleasing fragrance to a non-pleasing fragrance and provides for a maximum “prank” effect on the user (i.e., there is no gradual transition between the pleasing fragrance and the non-pleasing fragrance). If the first layer and the second layer are allowed to intermix, then the user will detect a faint non-pleasing fragrance intermixed with the pleasing fragrance, with the non-pleasing fragrance getting stronger over time only if the user does not stop further burning of the wick. It is likely in the case of an intermixed margin at the intersection of the first layer and the second layer that the user would notice the non-pleasing fragrance and stop the wick from burning before a fully non-pleasing odor dominates during burning of the wick into the second layer.

In some embodiments, the first layer comprises about 40% by volume of the candle. Thus, in some embodiments, the first layer can comprise about 10-70%, 15-65%, 20-60%, 25-55%, 30-50%, or 35-45% by volume of the candle. In some embodiments, the second layer comprises about 25% by volume of the candle. Thus, in some embodiments, the second layer can comprise about 5-45%, 10-40%, 15-35%, or 20-30% by volume of the candle. In embodiments wherein candle 10 comprises a third layer, the layer can comprise about 35% by weight of the candle. Thus, in some embodiments, the third layer can comprise about 5-65%, 10-60%, 15-55%, 20-50%, 25-45%, or 30-40% by volume of the candle. In some embodiments, the volume of the first, second, and/or third layers can be chosen so that each layer burns for a desired period of time, as would be known in the art.

In some embodiments, first and/or second layers 14, 16 comprise one or more pigments or dyes such that the candle layers are colored. In some embodiments, the first, second, and/or third layers are the same color. In some embodiments, the first, second, and/or third layers are different colors. Suitable pigments and/or dyes are known to those of ordinary skill in the art.

Although depicted as cylindrical in shape in the Figures, candle 10 can be constructed in any known shape, including (but not limited to) cylindrical, oval, square, triangular, rectangular, hexagonal, pyramidal, spherical, abstract, and the like.

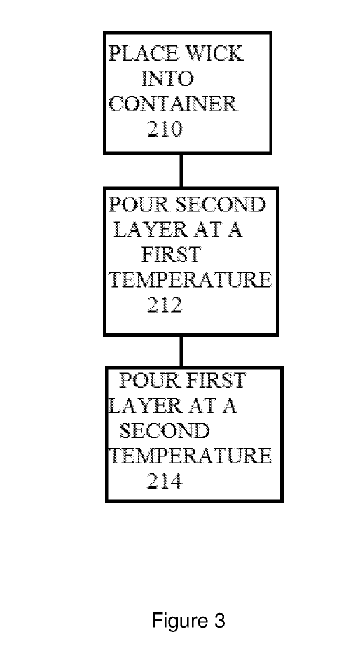

FIG. 3 illustrates one method of constructing candle 10 in accordance with some embodiments of the presently disclosed subject matter. As illustrated, the method includes first step 210 of positioning a wick into a container. The method further includes second step 212 of pouring the second or bottom layer at a first temperature and allowing the second layer to settle and then form and solidify. The method further includes third step 214 of pouring the first or top layer at a second temperature that is less than the first temperature and allowing the first layer to settle and then form and solidify. It should be appreciated that larger molds or containers can be utilized to make candles having additional layers that have additional or different fragrances, or are unscented. In these embodiments, additional layers are sequentially added prior to or after the first and second layers as described above. Candle 10 can be in the form of a freestanding candle (such as a pillar candle) or can be positioned in or upon a container (such as a glass, ceramic, or metal container).

In use, a user first lights exposed portion 18 of wick 12 to begin the burn phase. During the burn phase, the wax in first layer 14 is melted and capillary action denotes that the pleasant fragrance of the first layer is thereby released with the molten wax and drawn up the burning wick into its immediate surroundings. Once the first layer has been melted and burned, the wick will melt the wax of second layer 16. As set forth above, because the first layer was poured at a temperature that is less than the temperature of the second layer during construction of the candle, there is no intermixing of fragrances between the first and second layers. As a result, once the wick begins to burn into the second layer, users will experience an abrupt odor change from pleasant (first layer 14) to unpleasant fragrance (second layer 16).

The descriptions of the various embodiments of the presently disclosed subject matter have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A candle comprising:
at least one wick extending along a length of the candle and having an exposed portion for burning;
a first layer defined proximal the exposed portion, the first layer comprising a fuel element having a desirable fragrance impregnated therein; and
a second layer positioned below the first layer, the second layer comprising a fuel element having an undesirable fragrance impregnated therein such that as the wick burns through the first layer into the second layer, the fragrance transitions from desirable to undesirable,
wherein there is a distinct transition between the first and second layers.

2. The candle according to claim 1, further including a third layer positioned below the second layer, wherein the third layer is not impregnated with a fragrance.

3. The candle according to claim 1, wherein the second layer is poured at a first temperature into a mold or a container, and the first layer is poured at a second temperature less than the first temperature into the mold or the container.

4. The candle according to claim 3, wherein the second temperature is selected so as to not melt the second layer when the first layer is being poured such that a distinct transition occurs between the first layer and the second layer.

5. The candle according to claim 1, wherein the first layer comprises about 40-80% by volume of the candle and the second layer comprises about 20-60% by volume of the candle before the candle is burned.

6. The candle according to claim 2, wherein the first layer comprises about 40% by volume of the candle, the second layer comprises about 25% by volume of the candle, and the third layer comprises about 35% by volume of the candle before the candle is burned.

7. The candle according to claim 1, wherein the fuel element of the first and second layers is selected from the group comprising: paraffin wax, triglyceride wax, animal wax, soy wax, beeswax, stearin wax, microcrystalline wax, carnauba wax, palm wax, and blends thereof.

8. The candle according to claim 1, wherein the concentration of fragrance in the second layer is 125% or more of the concentration of fragrance present in the first layer.

9. The candle according to claim 1, wherein the undesirable fragrance is one of a pungent or obnoxious fragrance configured to produce a pungent or obnoxious fragrance when burned.

10. The candle according to claim 1, wherein at least one of the first or second layers comprises a dye or pigment.

11. The candle according to claim 10, wherein the first and second layers are the same color.

12. A method of making the candle of claim 1, the method comprising:
providing a container or mold;
positioning at least one wick in the container or mold such that the wick extends at least partially along the length of the container or mold;
heating the second layer to a first temperature and pouring it into the container or mold;
allowing the second layer to solidify;
heating the first layer to a second temperature that is less than the first temperature and pouring it into the container or mold;
allowing the second layer to solidify; and
recovering the candle from the container or mold.

13. The method of claim 12, wherein the second temperature is selected so as to not melt the second layer when the first layer is being poured.

14. The method of claim 12, wherein the first layer comprises about 40-80% by volume of the candle and the second layer comprises about 20-60% by volume of the candle before the candle is burned.

15. The method of claim 12, wherein the concentration of fragrance in the second layer is 125% or more of the concentration of fragrance present in the first layer.

16. The method of claim 12, wherein the undesirable fragrance is one of a pungent or obnoxious fragrance configured to produce a pungent or obnoxious fragrance when burned.

17. The method of claim 12, wherein at least one of the first or second layers comprises a dye or pigment.

18. The method of claim 17, wherein the first and second layers are the same color.
